(19) United States
(12) Patent Application Publication
(10) Pub. No.: US 2026/0297434 A1
(43) Pub. Date: Oct. 1, 2026

(54) APPLICATION OF A BOTTOM DIVIDED WALL COLUMN (BDWC) WITH AND WITHOUT VAPOR RECOMPRESSION (VRC) TO SEPARATE AROMATIC RICH STREAMS FROM THE PYROLYSIS GASOLINE HYDROGENATION REACTOR

(71) Applicant: Lummus Technology LLC, Houston, TX (US)

(72) Inventors: Krishna Prasad Chokkara, Houston, TX (US); Sirkanta Kumar Ghosh, Houston, TX (US); Marc Andrew Laurin, Houston, TX (US); Gaurav Chaturvedi, Houston, TX (US); Muzaffar Mahmood Khan, Houston, TX (US)

(73) Assignee: Lummus Technology LLC, Houston, TX (US)

(21) Appl. No.: 19/631,606

(22) Filed: Mar. 27, 2026

(30) Foreign Application Priority Data
Mar. 28, 2025 (IN) 202521029931

(51) Int. Cl. C10G 7/00; B01D 3/00; B01D 3/14; B01D 3/32; C10G 67/02

(52) U.S. Cl. CPC C10G 7/00; B01D 3/007; B01D 3/141; B01D 3/322; C10G 67/02; C10G 2400/02; C10G 2400/22; C10G 2400/30

(57) ABSTRACT

Systems and process for separating a hydrotreated pyrolysis gasoline include feeding a hydrotreated pyrolysis gasoline to a divided wall distillation column. The divided wall distillation column includes: a bottom dividing wall segregating a lower portion of the column into a first side and a second side, wherein the hydrotreated pyrolysis gasoline is fed to the first side; and an upper separation zone receiving vapor from both of the first side and second side and providing liquid to both of the first side and second side. The divided wall distillation column is configured to separate the hydrotreated pyrolysis gasoline to recover an overheads fraction comprising C6 hydrocarbons, separate the hydrotreated pyrolysis gasoline in the first side to recover a first bottoms fraction comprising C9 and heavier hydrocarbons, and separate, in the second side, liquid received from the upper separation zone to recover a second bottoms fraction comprising C7-C8 hydrocarbons.

### FIELD OF THE DISCLOSURE

Embodiments of the present disclosure generally relate to the processing of cracked hydrocarbons. In more specific aspects, embodiments herein relate to the processing of cracker effluents and hydrocarbon fractions therefrom, such as a hydrotreated pyrolysis gasoline fraction, as well as the separation and recovery of desirable products from such processing.

### BACKGROUND

Various processes are used for converting higher molecular weight hydrocarbons, such as atmospheric residues, vacuum distillates, and/or vacuum residues, to useful or desirable intermediates and end products. Such processes may include thermal cracking, catalytic cracking, and other various hydroprocessing techniques. The cracked or hydroprocessed streams may then be separated into various hydrocarbon fractions having discrete boiling ranges, such as naphtha range hydrocarbons, gas oil range hydrocarbons, and other various fractions. For example, a steam cracker reactor effluent comprising cracked hydrocarbons may be separated to recover light olefins and paraffins, such as C2-C4 olefins and paraffins or C2-C5 olefins and paraffins, a pyrolysis gasoline product, and heavier fractions.

Prior to use of the pyrolysis gasoline as a gasoline blend stock, it may be hydrotreated (hydrogenated) to saturate diolefins and acetylenes contained in the pyrolysis gasoline stream. The pyrolysis gasoline may also be hydrotreated (hydro desulfurized) to remove sulfur contained in the pyrolysis gasoline stream, thus allowing the pyrolysis gasoline to undergo aromatics extraction. Following reaction with hydrogen in one or more hydrotreatment reactors, the hydrotreated pyrolysis gasoline may undergo hydrogen and hydrogen sulfide separations, such as in a hydrogen sulfide (H2S) stripper, producing a hydrotreated pyrolysis gasoline stream.

To facilitate capture of the aromatics and separation of the hydrotreated pyrolysis gasoline stream into desired fractions for blending or further processing, the hydrotreated pyrolysis gasoline fraction may be processed using a typical system as illustrated in FIG. 1. A hydrotreated pyrolysis gasoline fraction 110 may be fed to a reboiled and refluxed first distillation column 112. First distillation column 112 may be used to separate the hydrotreated pyrolysis gasoline to recover a bottoms fraction 114, including C9 and heavier hydrocarbons (a C9+ fraction), and an overheads fraction 116, including C8 and lighter hydrocarbons (a C8− fraction). The C8− fraction may then be fed to a second distillation column 118, which is also reboiled and refluxed. Second distillation column 118 may be used to separate the C8− fraction to recover a bottoms fraction 120, including C7 and C8 hydrocarbons, and an overheads fraction 122, including C6 and lighter hydrocarbons. The reflux systems may include condensation against cooling water and the reboiler systems may use medium pressure steam, for example.

Separation of the C6 fraction, C7-C8 fraction, and C9+ fractions from a pyrolysis gasoline hydrogenation (PGH) reactor effluent, such as by a process as illustrated in FIG. 1, represents an energy-intensive process.

### SUMMARY OF THE CLAIMED EMBODIMENTS

Global climate changes have forced modern industry to act towards environmental safety, which requires technological changes to the existing processes. Embodiments herein are directed toward processing of pyrolysis gasoline hydrogenation reactor effluents in efficient manners that may be less capital intensive, may require less overall operating expenses, and/or may be more environmentally friendly or less energy intensive.

In one aspect, embodiments disclosed herein relate to a process for separating a hydrotreated pyrolysis gasoline. The process includes feeding a hydrotreated pyrolysis gasoline to a divided wall distillation column. The divided wall distillation column includes: a bottom dividing wall segregating a lower portion of the divided wall distillation column into a first side and a second side, wherein the hydrotreated pyrolysis gasoline is fed to the first side; and an upper separation zone receiving vapor from both of the first side and second side and providing liquid to both of the first side and second side. The process includes separating the hydrotreated pyrolysis gasoline in the dividing wall distillation column to recover an overheads fraction comprising C6 hydrocarbons, separating the hydrotreated pyrolysis gasoline in the first side to recover a first bottoms fraction comprising C9 and heavier hydrocarbons, and separating, in the second side, liquid received from the upper separation zone to recover a second bottoms fraction comprising C7 and C8 hydrocarbons.

In another aspect, embodiments disclosed herein relate to a process for converting hydrocarbons to olefins and aromatics. The process includes steam cracking a hydrocarbon feedstock to produce a cracked effluent. The cracked effluent is then separated to recover one or more light hydrocarbon fractions (such as C2-C4 fractions or C2-C5 fractions), a pyrolysis gasoline fraction, and one or more heavy hydrocarbon fractions (such as C13+ hydrocarbons). The pyrolysis gasoline fraction is then hydrotreated in one or more reactors to recover a pyrolysis gasoline reactor effluent. Hydrogen and hydrogen sulfide are then separated from the pyrolysis gasoline reactor effluent to recover an offgas stream and a hydrotreated pyrolysis gasoline. The process then includes feeding the hydrotreated pyrolysis gasoline to a dividing wall distillation column. The dividing wall distillation column includes: a bottom dividing wall segregating a lower portion of the dividing wall distillation column into a first side and a second side, wherein the hydrotreated pyrolysis gasoline is fed to the first side; and an upper separation zone (enriching section) receiving vapor from both of the first side and second side and providing liquid to both of the first side and second side. In the dividing wall distillation column, the hydrotreated pyrolysis gasoline is separated to recover an overheads fraction comprising C6 hydrocarbons, the process further including separating the hydrotreated pyrolysis gasoline in the first side to recover a first bottoms fraction comprising C9 and heavier hydrocarbons, and separating, in the second side, liquid received from the upper separation zone to recover a second bottoms fraction comprising C7-C8 hydrocarbons.

In another aspect, embodiments disclosed herein relate to a system for processing hydrotreated pyrolysis gasoline. The system includes a dividing wall distillation column configured to receive a hydrotreated pyrolysis gasoline feed. The dividing wall distillation column includes: a bottom dividing wall segregating a lower portion of the divided wall distillation column into a first side and a second side, wherein the hydrotreated pyrolysis gasoline is fed to the first side; and an upper separation zone configured for receiving vapor from both of the first side and second side and providing liquid to both of the first side and second side. The dividing wall distillation column is configured to; separate the hydrotreated pyrolysis gasoline in the divided wall distillation column to recover an overheads fraction comprising C6 hydrocarbons; separate the hydrotreated pyrolysis gasoline in the first side to recover a first bottoms fraction comprising C9 and heavier hydrocarbons; and separate, in the second side, liquid received from the upper separation zone to recover a second bottoms fraction comprising C7-C8 hydrocarbons. The system further includes a flow splitter or valving configured to divide the overheads fraction into a first portion and a second portion, as well as a compressor for compressing the first portion to produce a compressed first portion. A first reboiler is provided for indirectly heating a portion or an entirety of the second bottoms fraction with the compressed first portion, producing a partially cooled first portion and for providing reboiling duty to the second side. Further, one or more coolers, interchangers and condensers are provided for cooling and condensing the partially cooled first portion and the second portion to produce a condensate, where a reflux drum is configured for receiving the condensed hydrocarbons. A reflux flow line is provided for feeding a portion of the condensate as reflux to a top tray of the upper separation zone of the divided wall distillation column. An overhead product line is provided for recovering a remaining portion of the condensate as a C6 product fraction. Further, a first heat exchanger allows for indirectly heating the hydrotreated pyrolysis gasoline with the second bottoms fraction, a second heat exchanger allows for indirectly heating the hydrotreated pyrolysis gasoline with the partially cooled first portion, producing a cooled first portion, and a compressor suction stream heater is provided for indirectly heating the first portion of the overheads fraction with the cooled first portion.

Other aspects and advantages will be apparent from the following description and the appended claims.

### BRIEF DESCRIPTION OF DRAWINGS

FIG. 1 illustrates a simplified process flow diagram of a prior art system for separating a hydrotreated pyrolysis gasoline.

FIGS. 2-4 illustrate a simplified process flow diagram for separating a hydrotreated pyrolysis gasoline according to one or more embodiments disclosed herein, where like numerals represent like parts.

### DETAILED DESCRIPTION

Embodiments of the present disclosure generally relate to processing of cracked hydrocarbon effluents, such as effluents from steam crackers or other crackers, hydrocrackers, and the like. The separation and treatment of the cracked effluents may include separation of the cracked effluents to recover a pyrolysis gasoline fraction. Processes herein may further process the pyrolysis gasoline recovered, such as by hydrogenation of the pyrolysis gasoline, as well as the separation and recovery of products from the pyrolysis gasoline hydrogenation reactor effluent.

Following steam cracking, or other thermal cracking processes, the cracked effluent(s) may undergo separation to recover various hydrocarbon fractions, including a pyrolysis gasoline fraction. Pyrolysis gasoline, in general, is a mixture of naphtha range hydrocarbons including aromatics, olefins, and paraffins ranging from C5s or C6s to C12s. In other embodiments, the pyrolysis gasoline fraction may include hydrocarbons boiling in the range of C6 to C11 hydrocarbons, C6 to C10 hydrocarbons, or C6 to C9 hydrocarbons, such as C6 to 180° C. boiling range hydrocarbons.

The pyrolysis gasoline fraction may then be fed to hydrogenation reactor(s) and reacted with hydrogen. The effluent from the pyrolysis gasoline hydrogenation reactor(s) may then undergo an initial separation step to separate unreacted hydrogen and any hydrogen sulfide or other acid gases from the hydrogenated effluent. The remaining hydrocarbons may then be fed from the initial separations, such as an H2S stripper, to a separation system according to embodiments herein, the separation system including a bottom divided wall column.

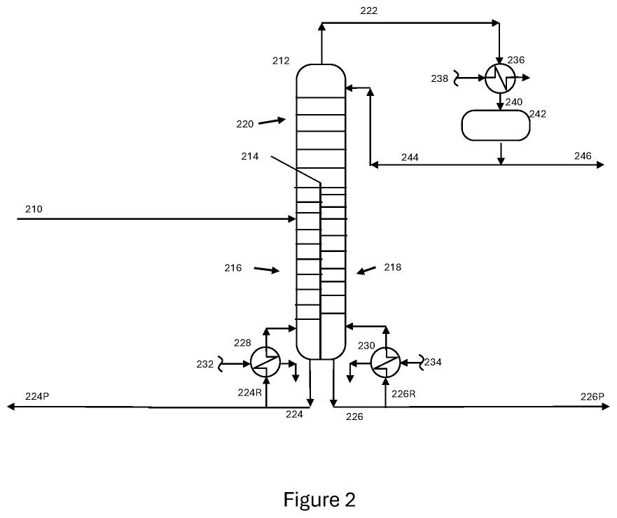

A simplified process flow diagram of a separation system for processing a hydrotreated pyrolysis gasoline according to some embodiments herein is illustrated in FIG. 2. The process for separating a hydrotreated pyrolysis gasoline includes feeding a hydrotreated pyrolysis gasoline 210 to a divided wall distillation column 212. The divided wall distillation column includes a bottom dividing wall 214 segregating a lower portion of the divided wall distillation column into a first side 216 and a second side 218. In some embodiments herein, the hydrotreated pyrolysis gasoline is fed to a feed tray located within first side 216.

The divided wall distillation column 212 includes an upper separation zone 220 (enriching section) receiving vapor traffic arising from both of the first side 216 and second side 218. The upper separation zone 220 additionally provides liquid traffic to both of the first side and second side. Various internals (not illustrated) may be used to regulate the flow of vapors from and flow of liquids to the first side and second side.

In the divided wall distillation column 212, the hydrotreated pyrolysis gasoline may be separated to recover an overhead draw 222 comprising C6 hydrocarbons. The hydrotreated pyrolysis gasoline 210 is separated in the first side 216 to recover a first bottoms fraction 224 comprising C9 and heavier hydrocarbons. Further, in the second side 218, liquid received from the upper separation zone 220 are separated to recover a second bottoms fraction 226 comprising C7 and C8 hydrocarbons. In this manner, the feed of the hydrotreated pyrolysis gasoline 210 and operating conditions (temperature profile, pressure profile, liquid and vapor traffic) within the divided wall distillation column may be used to isolate and separate the C9 and any heavier hydrocarbons in the first side 216, as well as to separate the C6 and any lighter hydrocarbons from the C7-C8 hydrocarbons in the upper section 220 and second side 218.

In some embodiments, such as illustrated in FIG. 2, vapor traffic to the first side is provided by a first reboiler 228, and vapor traffic to the second side is regulated by a second reboiler 230. The reboilers may be external to the column and may be kettle reboilers, thermosiphon reboilers or, as illustrated, forced circulation reboilers (associated pumps not illustrated). The first bottoms fraction 224, or a portion thereof (such as portion 224R as illustrated), may be fed to first reboiler 228 and heated in indirect heat exchange with a hot fluid 232, such as steam or any heating medium such as hot oil. The residual liquids from first reboiler, 228 or the portion not reboiled (as illustrated), may be recovered as a C9+ product fraction 224P. The second bottoms fraction 226, or a portion thereof (such as portion 226R, as illustrated), may be fed to second reboiler 230 and heated in indirect heat exchange with a hot fluid 234, such as steam or any heating medium such as hot oil. The residual liquids from second reboiler 230, or the portion not reboiled (as illustrated), may be recovered as a C7-C8 product fraction 226P. Liquid traffic at the top of the divided wall distillation column 212 may be provided by condensing the overhead draw 222, such as by indirect heat exchange in condenser 236 against a coolant 238, such as cold water, producing a condensate 240 collected in condensate drum 242. A portion of the condensed liquid collected in reflux drum 242 may be fed as liquid reflux 244 to a top tray of the divided wall distillation column, and a portion of the condensate may be withdrawn as a C6 product stream 246.

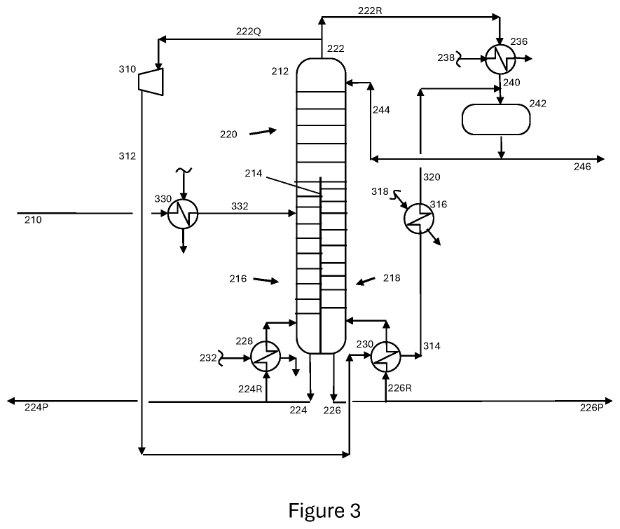

A simplified process flow diagram of a separation system for processing a hydrotreated pyrolysis gasoline according to other embodiments herein is illustrated in FIG. 3, where like numerals represent like parts. In the embodiment of FIG. 3, the separation scheme and separations achieved in the divided wall distillation column is similar to that of FIG. 2. In this embodiment, the system further includes a heat pump for reboiling (providing reboil vapor/heat input to) the second side of the divided wall distillation column.

Overhead draw 222 may be split (no componential separations) into a first overhead portion 222R and a second overhead portion 222Q. The flow may be divided, for example, using a tee and appropriate valving (not shown). Second overhead portion 222Q may then be compressed in compressor 310 to produce a compressed second overhead portion 312. Rather than using steam or another heating fluid, vapor traffic to the second side 218 of divided wall distillation column 212 may be provided by indirectly heating a portion 226R or an entirety of the second bottoms fraction with the compressed second portion 312, producing a partially cooled second portion 314.

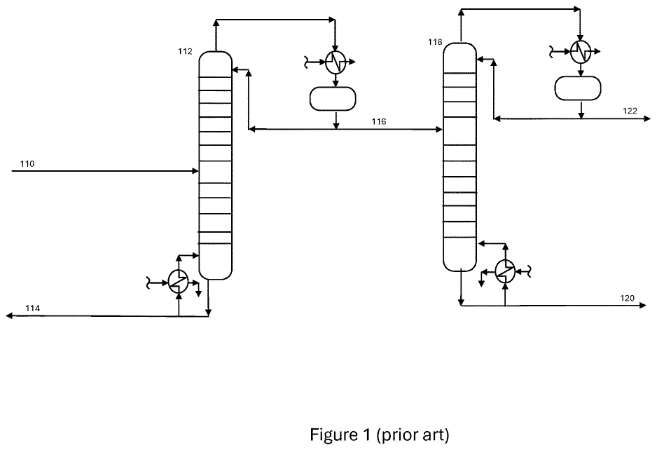

Liquid traffic to the top of the column may be provided by condensing the partially cooled second overhead portion 314 and the first overhead portion 222R to produce a condensed liquid. First overhead portion 222R may be processed as in FIG. 1, condensing the vapors in condenser 236, while partially cooled second overhead portion may be condensed in condenser 316 against a coolant 318, such as cold water, producing a condensate 320. Condensates 320 and 240 may then be combined and fed to Reflux drum 242 to provide reflux 244 and C6 product draw 246.

In some embodiments, it may be additionally desired to pre-heat the hydrotreated pyrolysis gasoline 210 prior to feeding it to the first side 216 of divided wall distillation column 212. As illustrated in FIG. 3, a feed preheater 330 may be provided, preheating and possibly vaporizing a portion of the feed prior to its introduction onto a feed tray or feed trays, as may be used for introducing the heated feed 332 or vapor and liquid portions of the heated feed 332.

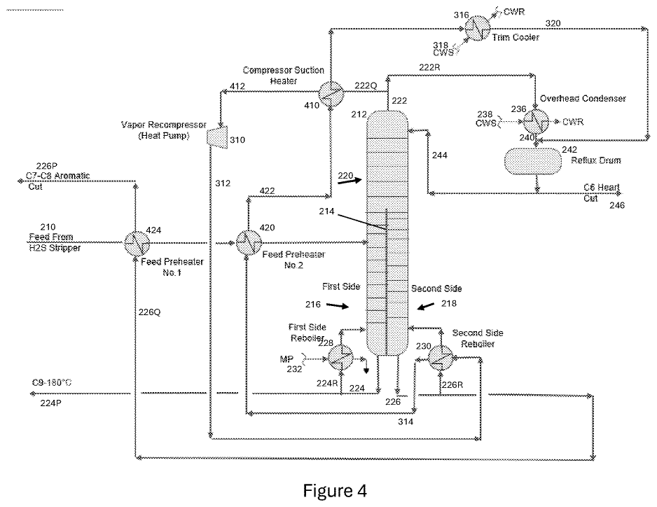

A simplified process flow diagram of a separation system for processing a hydrotreated pyrolysis gasoline according to further embodiments herein is illustrated in FIG. 4, where like numerals represent like parts. In the embodiment of FIG. 4, the separation scheme and separations achieved in the divided wall distillation column is similar to that of FIGS. 2 and 3. In this embodiment, the system further includes a heat pump for reboiling (providing reboil vapor/heat input to) the second side of the divided wall distillation column, as well as feed preheating and compressor suction stream preheating.

Similar to the embodiment of FIG. 4, overhead draw 222 may be split (no componential separations) into a first overhead portion 222R and a second overhead portion 222Q. The flow may be divided, for example, using a tee and appropriate valving (not shown). Second overhead portion 222Q may then be superheated in compression suction heater 410 and superheated second overhead portion 412 may be compressed in compressor 310 to produce a compressed second overhead portion 312. Rather than using steam or any another heating medium, vapor traffic to the second side 218 of divided wall distillation column 212 may be provided by indirectly heating a portion 226R or an entirety of the second bottoms fraction with the compressed second portion 312, producing a partially cooled second portion 314.

Liquid traffic to the top of the column may be provided by condensing the partially cooled second overhead portion 314 and the first overhead portion 222R to produce a condensate. First overhead portion 222R may be processed as in FIG. 1, condensing the vapors in condenser 236, while partially cooled second overhead portion may be further cooled and condensed in a series of exchangers to produce condensate 320. As illustrated in FIG. 4, the series of exchangers may include Feed preheater No.2 420, compressor suction heater 410, and a trim cooler 316. Partially cooled second portion 314 may be cooled against the hydrotreated pyrolysis gasoline feed 210 in Feed preheater No.2 420, producing a cooled first portion 422. Cooled first portion 422 may then be used to superheat second overhead portion 222Q in compressor suction heater 410, and then cooled in trim cooler 316 against a coolant 318, such as cooling water, producing a condensate 320. Condensed liquids 320 and 240 may then be combined and fed to Reflux drum 242 to provide reflux 244 and C6 product draw 246.

Additional feed preheating may be provided by Feed preheater No.1 424, indirectly heating the hydrotreated pyrolysis gasoline 210 with the second bottoms fraction 226Q, producing a cooled C7-C8 product draw 226P. While not illustrated, embodiments herein further contemplate recovering heat from first bottoms draw 224P and C6 product draw 246, one or both of which may also be used to provide heat to one or more streams.

To perform the desired separations within the divided wall distillation column, the divided wall distillation column may be operated at an overhead temperature in a range from about 70° C. to about 90° C. and at an overhead pressure in a range from about 0.8 to about 1.2 bar. The first side of the divided wall distillation column, separating the C9 or C9+ components, may be operated at a bottoms temperature in a range from about 150° C. to about 185° C. The second side of the divided wall distillation column, separating the C7-C8 components from the C6 or C6− components, may be operated at a bottoms temperature in a range from about 110° C. to about 140° C.

In embodiments using a heat pump, the second overhead portion may be compressed from the overhead temperature of 70° C. to 90° C. to produce a compressed first portion having a temperature in a range of 135° C. to 150° C. and a pressure in a range from about 3.5 bar to 6 bar. The relative portion of the vapor drawn into compressor 310, and the temperature following compression, should be sufficient to provide the desired heat to second side reboiler 230 and any additional heating requirements, such as in Feed preheater No.2 420 and compressor suction heater 410, when used.

As outlined above, embodiments of separation systems according to embodiments herein may be used in a process for converting hydrocarbons to olefins and aromatics. For example, a hydrocarbon feedstock may be steam cracked to produce a cracked effluent, which may be separated to recover one or more light hydrocarbon fractions (C2-C4 hydrocarbons or C2-C5 hydrocarbons), a pyrolysis gasoline fraction (C5 or C6 to C9, C10, C11, or C12 hydrocarbons), and one or more heavy hydrocarbon fractions (C10+, C11+, C12+, or C13+ hydrocarbons, for example).

The pyrolysis gasoline fraction may then be hydrotreated in one or more reactors to recover a pyrolysis gasoline reactor effluent, following which hydrogen and hydrogen sulfide may be separated from the pyrolysis gasoline reactor effluent to recover an offgas stream and a hydrotreated pyrolysis gasoline. The hydrotreated pyrolysis gasoline may then be fed to a separation system according to embodiments herein, such as illustrated in one of FIGS. 2-4, for separation of the hydrotreated pyrolysis gasoline to recover the desired products, including a C6 heart cut, a C7-C8 aromatic cut, and a C9+ fraction.

Systems and processes herein, and as described above, may utilize a divided wall column system for separation of a C6 heart cut, C7-C8 aromatics rich cut and C9-180° C. cut from a pyrolysis gasoline hydrogenation reactor effluent. The C6 heart cut may be, for example, a crude benzene cut from the reactor effluent, and the C7-C8 cut may provide a crude toluene and mixed xylene stream, both of which may be processed to recover aromatics. The separation systems according to embodiments herein is more energy efficient, the system requiring comparatively lower operating costs, as well as comparatively lower investment costs, as compared to a typical separation system, such as that described with respect to FIG. 1.

In accordance with the present disclosure, embodiments herein provide a divided wall column system where a dividing wall is positioned in the bottom section of the column to divide the bottom section into a first side and a second side. The first side may include a reboiler (C9-180° C. side) outside of the dividing wall column that is connected with the first side of the bottom section. The second side may include a second reboiler (C7-C8 aromatics rich cut) outside of the dividing wall column that is connected with the second side of the bottom section of the dividing wall column. In some embodiments, a heat pump is connected with the overhead product from the dividing wall column, where the heat pump provides the duty requirement for second reboiler.

The energy consumption of the dividing wall column system in embodiments herein, when used as a BTX tower/Dehexanizer, is decreased significantly compared to a typical separation system, at the same time high separation efficiency is maintained. The vapor generated in the first reboiler is used to strip the feed (reactor effluent) on the first side of the bottom section of the dividing wall which produces a C9-180 C hydrocarbon product on first side of the bottom section of the dividing wall column. Similarly, the vapor generated in the second reboiler is used to strip C6 heart cut hydrocarbons to the top of the dividing wall column. All in all, according to embodiments of the present disclosure, the overhead product or vapor, produced by the dividing wall column is used to heat the second side or C7-C8 aromatics cut reboiler. The remainder of the overhead vapor will be routed to a conventional overhead condenser before being collected in the accumulator. The dividing wall column is operated at near atmospheric pressure. As such, by condensing this vapor stream via heat pump in the reboiler, cooling water requirements in the condenser and heating medium requirements in the reboiler get reduced. Thus, the present disclosure relates to a heat integration scheme that uses a heat pump to compress the overhead vapor obtained in the dividing wall column to use this stream as heating medium in the the second reboiler of the dividing wall column.

In some embodiments, it was found that there was a mixed phase at the compressor discharge. This was due to compression of saturated hydrocarbons. In such embodiments, to overcome this, a small suction heater is added in the compressor suction, which super-heats column overhead before compression and prevents condensation at the compressor discharge.

Bottom-DWCs according to embodiments herein will have two separate reboilers and have the advantage of maintaining the bottoms utility at two different temperature levels. To increase the overall economics of the process scheme, embodiments herein include a vapor recompression option. In this scheme, a slipstream from the column overhead is preheated before being compressed and used as a heating source in the reboiler on the C7-C8 side and preheat the feed coming to this column. By doing this, medium pressure steam consumption is reduced (38% reduction over the conventional scheme of FIG. 1) in the BDWC and cooling water consumption is reduced (33% reduction over the conventional scheme of FIG. 1) in the overhead condenser.

Since bottom divided wall columns eliminates remixing of components that generally happens in the conventional column, higher product purities are achievable with lesser number of stages and lower condenser/reboiler duties.

Thus, the bottom divided wall column with and without vapor recompression according to embodiments herein represents a significant advancement in multicomponent mixture separation with considerable reduction in the utility consumption and capital investment in comparison to the conventional process scheme.

Embodiments herein thus provide one, two, or all of capital cost saving, operating cost saving and reduction in CO2 emission. In particular, embodiments herein may have the following advantages compared to conventional process scheme: (i) reduced utility consumption (medium pressure steam and cooling water); (ii) reduced capital investment (lower equipment piece count, smaller equipment sizes); (iii) reduced plot area requirements; and (iv) reduced greenhouse gas emission from the cracker and associated units.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process for separating a hydrotreated pyrolysis gasoline, comprising
feeding a hydrotreated pyrolysis gasoline to a divided wall distillation column, the divided wall distillation column including:
a bottom dividing wall segregating a lower portion of the divided wall distillation column into a first side and a second side, wherein the hydrotreated pyrolysis gasoline is fed to the first side; and
an upper separation zone receiving vapor from both of the first side and second side and providing liquid to both of the first side and second side;
separating the hydrotreated pyrolysis gasoline in the divided wall distillation column to recover an overheads fraction comprising C6 hydrocarbons;
separating the hydrotreated pyrolysis gasoline in the first side to recover a first bottoms fraction comprising C9 and heavier hydrocarbons;
separating, in the second side, liquid received from the upper separation zone to recover a second bottoms fraction comprising C7 and C8 hydrocarbons.

2. The process of claim 1, further comprising:
dividing the overheads fraction into a first portion and a second portion;
compressing the first portion to produce a compressed first portion;
reboiling the second side by indirectly heating a portion or an entirety of the second bottoms fraction with the compressed first portion, producing a partially cooled first portion;
cooling and condensing the partially cooled first portion and the second portion to produce a condensate;
feeding a portion of the condensed liquid as reflux to a top tray of the upper separation zone of the divided wall distillation column; and
recovering a remaining portion of the condensate as a C6 product fraction.

3. The process of claim 2, further comprising:
heating the hydrotreated pyrolysis gasoline upstream of the divided wall distillation column.

4. The process of claim 3, wherein heating the hydrotreated pyrolysis gasoline comprises indirectly heating the hydrotreated pyrolysis gasoline with the second bottoms fraction.

5. The process of claim 2, further comprising indirectly heating the hydrotreated pyrolysis gasoline with the partially cooled first portion, producing a cooled first portion.

6. The process of claim 5, further comprising indirectly heating the first portion of the overheads fraction with the cooled first portion.

7. The process of claim 2, further comprising:
heating the first portion of the overheads fraction prior to compressing the first portion.

8. The process of claim 7, wherein heating the first portion of the overheads comprises indirectly heating the first portion with the partially cooled first portion.

9. The process of claim 1, further comprising:
dividing the overheads fraction into a first portion and a second portion;
compressing the first portion to produce a compressed first portion;
reboiling the second side by indirectly heating a portion or an entirety of the second bottoms fraction with the compressed first portion, producing a partially cooled first portion;
cooling and condensing the partially cooled first portion and the second portion to produce a condensate;
feeding a portion of the condensate as reflux to a top tray of the upper separation zone of the divided wall distillation column; and
recovering a remaining portion of the condensate as a C6 product fraction;
indirectly heating the hydrotreated pyrolysis gasoline with the second bottoms fraction;
indirectly heating the hydrotreated pyrolysis gasoline with the partially cooled first portion, producing a cooled first portion;
indirectly heating the first portion of the overheads fraction with the cooled first portion.

10. A process for converting hydrocarbons to olefins and aromatics, comprising:
steam cracking a hydrocarbon feedstock to produce a cracked effluent;
separating the cracked effluent to recover one or more light hydrocarbon fractions, a pyrolysis gasoline fraction, and one or more heavy hydrocarbon fractions;
hydrotreating the pyrolysis gasoline fraction in one or more reactors to recover a pyrolysis gasoline reactor effluent;
separating hydrogen and hydrogen sulfide from the pyrolysis gasoline reactor effluent to recover an offgas stream and a hydrotreated pyrolysis gasoline;
feeding the hydrotreated pyrolysis gasoline to a divided wall distillation column, the divided wall distillation column including:
a bottom dividing wall segregating a lower portion of the divided wall distillation column into a first side and a second side, wherein the hydrotreated pyrolysis gasoline is fed to the first side; and
an upper separation zone receiving vapor from both of the first side and second side and providing liquid to both of the first side and second side;
separating the hydrotreated pyrolysis gasoline in the divided wall distillation column to recover an overheads fraction comprising C6 hydrocarbons;
separating the hydrotreated pyrolysis gasoline in the first side to recover a first bottoms fraction comprising C9 and heavier hydrocarbons;
separating, in the second side, liquid received from the upper separation zone to recover a second bottoms fraction comprising C7 and C8 hydrocarbons.

11. The process of claim 10, further comprising:
dividing the overheads fraction into a first portion and a second portion;
compressing the first portion to produce a compressed first portion;
reboiling the second side by indirectly heating a portion or an entirety of the second bottoms fraction with the compressed first portion, producing a partially cooled first portion;
cooling and condensing the partially cooled first portion and the second portion to produce a condensate;
feeding a portion of the condensed liquid as reflux to a top tray of the upper separation zone of the divided wall distillation column; and
recovering a remaining portion of the condensed liquid as a C6 product fraction;
indirectly heating the hydrotreated pyrolysis gasoline with the second bottoms fraction;
indirectly heating the hydrotreated pyrolysis gasoline with the partially cooled first portion, producing a cooled first portion;
indirectly heating the first portion of the overheads fraction with the cooled first portion.

12. The process of claim 11, further comprising:
operating the divided wall distillation column at an overhead temperature in a range
from about 70° C. to about 90° C. and at an overhead pressure in a range from about 0.8 to about 1.2 bar;
operating the first side of the divided wall distillation column at a bottoms temperature in a range from about 150° C. to about 185° C.; and
operating the second side of the divided wall distillation column at a bottoms temperature in a range from about 110° C. to about 140° C.

13. The process of claim 11, wherein the compressing comprises compressing the first portion to produce a compressed first portion having a temperature in a range of 135° C. to 150° C. and a pressure in a range from about 3.5 bar to 6 bar.

14. A system comprising:
a divided wall distillation column configured to receive a hydrotreated pyrolysis gasoline, the divided wall distillation column including:
a bottom dividing wall segregating a lower portion of the divided wall distillation column into a first side and a second side, wherein the hydrotreated pyrolysis gasoline is provided to the first side; and
an upper separation zone configured for receiving vapor from both of the first side and second side and providing liquid to both of the first side and second side;
wherein the divided wall distillation column is configured to:
separate the hydrotreated pyrolysis gasoline in the divided wall distillation column to recover an overheads fraction comprising C6 hydrocarbons;
separate the hydrotreated pyrolysis gasoline in the first side to recover a first bottoms fraction comprising C9 and heavier hydrocarbons;
separate, in the second side, liquid received from the upper separation zone to recover a second bottoms fraction comprising C7-C8 hydrocarbons;
a flow splitter or valving configured to divide the overheads fraction into a first portion and a second portion;
a compressor for compressing the first portion to produce a compressed first portion;
a first reboiler for indirectly heating a portion or an entirety of the second bottoms fraction with the compressed first portion, producing a partially cooled first portion and for providing reboiling duty to the second side;
one or more coolers, interchangers and condensers for cooling and condensing the partially cooled first portion and the second portion to produce a condensed liquid;
a reflux drum for receiving the condensed liquid;
a reflux flow line for feeding a portion of the condensed liquid as reflux to a top tray of the upper separation zone of the divided wall distillation column; and
an overhead product line for recovering a remaining portion of the condensed liquid as a C6 product fraction;
a first heat exchanger for indirectly heating the hydrotreated pyrolysis gasoline with the second bottoms fraction;
a second heat exchanger for indirectly heating the hydrotreated pyrolysis gasoline with the partially cooled first portion, producing a cooled first portion; and
a compressor suction stream heater for indirectly heating the first portion of the overheads fraction with the cooled first portion.
